(19) United States
(12) Patent Application Publication
(10) Pub. No.: US 2012/0048307 A1
(43) Pub. Date: Mar. 1, 2012

(54) METHOD AND SYSTEM FOR DISPENSING INCOMPATIBLE PRODUCTS

(75) Inventors: JOHN THOMAS PELKEY, ST. PAUL, MN (US); RYAN JACOB URBAN, MAHTOMEDI, MN (US); SCOTT RUSSELL LIMBACK, ST. PAUL, MN (US)

(73) Assignee: ECOLAB USA INC., ST. PAUL, MN (US)

(21) Appl. No.: 12/868,100

(22) Filed: Aug. 25, 2010

(51) Int. Cl. B08B 3/00; B67D 7/00; B67D 7/78

(52) U.S. Cl. 134/36; 222/1; 222/133

(57) ABSTRACT

A method and system provides for dispensing incompatible products. Separate aspirator assemblies (12A and 12B) are connected in fluid communication with a single liquid diluent source (54). A first set of liquid products (48A-51A) are drawn through aspirator assembly (12A) and a second set of liquid products (48B-51B) having a product incompatible with the first set are drawn through another aspirator assembly (12B). Incompatible liquid products are thereby dispensed independent of and in separation from one another to an appliance for use.

### BACKGROUND OF THE INVENTION

1. Field of the Invention

This invention relates generally to a method and system for dispensing incompatible products, and more particularly to a method and system for dispensing incompatible liquid products from a dispenser using separate aspirators to prevent product mixing in concentrated or diluted form.

2. Description of the Prior Art

Many cleaning and sanitizing processes, whether laundering, warewashing or the like use various and sundry formulated aqueous products, some of which are incompatible with other products. Furthermore, the effectiveness of most, if not all, cleaning and sanitizing processes is limited if mixed with an incompatible product. In fact, selected aqueous products, such as incompatible chemical agents, if mixed together can result in noxious and even toxic fumes, and unwanted premature activation of chemicals and/or unwanted precipitants. For example, hospitality businesses such as hotels, hospitals, restaurants and the like use liquid detergents and cleaning solutions for laundry and warewashing. These processes often require incompatible solutions to be used to increase the effectiveness of the cleaning and sanitizing process. Accordingly, care must be taken to ensure that incompatible products are not mixed during any of these processes. To achieve these objectives, many efforts have been made to control the delivery of concentrated liquid products. One common delivery mode involves utilizing a dispensing device that combines, under mixing conditions, a flow of concentrate and then a flow of diluent. The flow of liquid diluent can be directed through an aspirator such that, as the diluent passes through the aspirator, a negative pressure arises inside the aspirator drawing the liquid concentrate into the aspirator to mix with the liquid diluent, which is in-turn delivered to an appliance for use. Both Copeland, et al., U.S. Pat. No. 5,033,649 and Freeze, U.S. Pat. No. 4,817,825 and Mehus, et al., U.S. Pat. No. 5,915,592 disclose dispensers having aspirators for diluting liquid concentrates to deliver liquid products in this general way. Such aspirator-type dispensers have been used for diluting, dispensing and delivering a liquid concentrate, but not incompatible liquid products.

In a number of applications, there is a desire to deliver incompatible liquid products by aspiration for use in cleaning and sanitizing processes.

The present invention addresses these problems and provides for a method and system for dispensing incompatible liquid components entirely by aspiration.

In addition, the present invention addresses the need to separate and maintain independent flow streams for incompatible liquid products being dispensed by aspiration to an appliance for use in a cleaning, sanitizing or like processes.

### BRIEF SUMMARY OF THE INVENTION

In one embodiment, the invention is a method for dispensing incompatible liquid products from a dispenser. The method includes providing a first and second aspirator, each having a diluent inlet port, a plurality of product inlet ports and an outlet port. A first liquid product is aspirated through a product inlet port of the first aspirator and a second liquid product being incompatible with the first liquid product is aspirated through a product inlet port of the second aspirator. The first liquid product is dispensed out an outlet port of the first aspirator and the second liquid product out an outlet port of the second aspirator in separation from the first liquid product.

In another embodiment, the invention is a product dispensing system configured to dispense incompatible liquid products. The system has a boost pump having a pump inlet for receiving a liquid diluent at a source pressure and a pump outlet for delivering the liquid diluent at an elevated pressure. A first and second aspirator each have a diluent inlet port for receiving the liquid diluent at the elevated pressure and a plurality of product inlet ports for receiving a liquid product and an outlet port for dispensing the product. A first set of liquid products are connected in liquid communication to a plurality of product inlet ports of the first aspirator for aspirating each liquid product into the first aspirator. Similarly, a second set of liquid products are connected in liquid communication to the plurality of product inlet ports of the second aspirator for aspirating each liquid product into the second aspirator. At least one product of the second set of liquid products is incompatible with at least one product of the first set of liquid products Likewise, at least one product of the first set of liquid products is aspirated solely through the first aspirator to prevent it from mixing with an incompatible product of the second set of liquid products.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings, in which:

FIG. 1 is a schematic representation of the present invention; and

FIG. 2 is a schematic representation of the present invention and incorporated into a commercial laundry system.

### DETAILED DESCRIPTION OF THE PREFERRED EMBODIMENTS

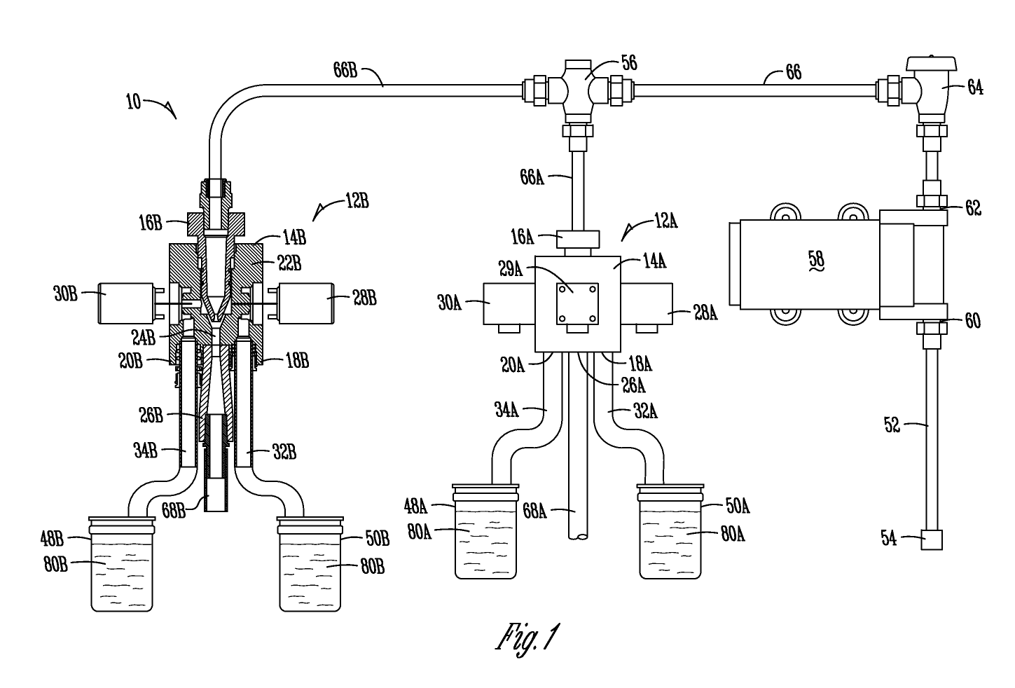

Referring to the drawings, wherein like numerals represent like parts throughout the several views, there is generally disclosed at 10 a dispensing system. The dispensing system 10 includes a pair of aspirator assemblies 12A and 12B. The dispensing system 10 could include two or more aspirator assemblies. For example, the dispensing system 10 could be refigured to include two or more aspirator assemblies depending upon the number of incompatible liquid products being dispensed and/or appliances being supported by the dispensing system 10. Therefore, the present dispensing system 10 could be reconfigured with any number of aspirator assemblies for dispensing any number of incompatible liquid products. Each aspirator assembly 12A and 12B include an aspirator 14A and 14B. Each aspirator assembly also includes four solenoid valves 28A-31A and 28B-31B (solenoid valves 31A and 31B not shown). The number of solenoid valves on each aspirator assembly could also be reconfigured according to need. For example, one or both of the aspirator assemblies 12A-B could be configured to include less than the four solenoid valves 28A-B and 31A-B illustrated (and solenoid valve 31A-B not shown). For example, aspirator assembly 12A could be configured with two solenoid valves instead of the standard four. Therefore, in the case where the dispensing system 10 includes the need for dispensing six separate liquid products, one of the aspirator assemblies could be configured with four solenoid valves connected to four liquid products and the other aspirator assembly could be configured with two solenoid valves connected to the remaining two liquid products. Other configurations are contemplated as circumstances may suggest or render expedient. Each aspirator assembly 12A-12B also includes a diluent inlet port 16A and 16B. The diluent inlet port is connected in fluid communication with respective passageways 24B (and 24A not shown) within the body of the aspirator as best shown by aspirator assembly 12B in FIG. 1. Each aspirator assembly 12A and 12B may also include four product inlet ports. Aspirator assembly 12A includes product inlet ports 18A-21A and aspirator assembly 12B includes four product inlet ports 18B-21B (product inlet ports 19A-B and 21A-B are not visible in FIG. 1). Passageway 24B within aspirator body 22B is in fluid communication with outlet port 26B, and aspirator assembly 12A is configured identically. A similar multi-port aspirator is disclosed in application Ser. No. 11/206,618 entitled “METHOD AND APPARATUS FOR DISPENSING A USE SOLUTION” filed on Aug. 18, 2005 and is hereby incorporated by reference in its entirety.

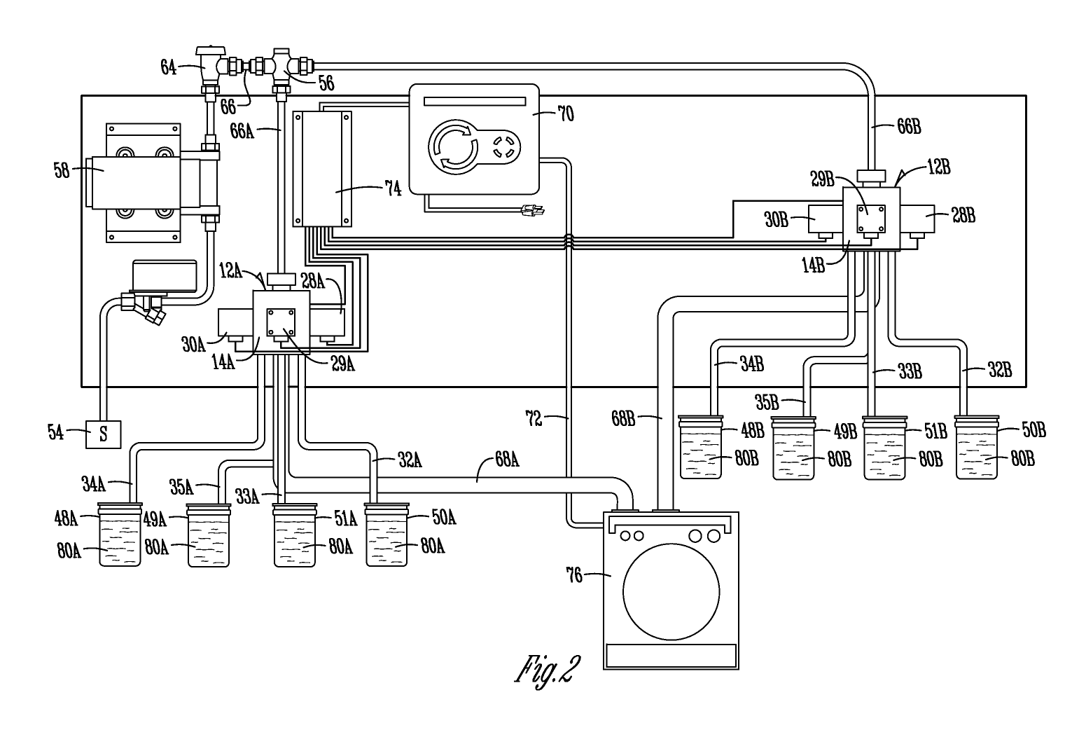

Product inlet ports 18A-21A (and two not shown) of aspirator assembly 12A are connected in fluid communication to liquid product containers 48A-51A (49A and 51A shown in FIG. 2) via liquid product conduits 32A-35A (33A and 35A shown in FIG. 2). Similarly, liquid product inlet ports 18B-21B (and two not shown) of aspirator assembly 12B are connected in fluid communication to product containers 48B-51B (49B and 51B shown in FIG. 2) via liquid product conduits 32B-35B (33B and 35B shown in FIG. 2).

While the previously described dispensing system 10 is preferred to be used in the present invention, it is understood that other suitable assemblies may also be used in combination with the dispensing system 10. Referring to FIG. 1, there is shown one embodiment utilizing one dispensing system of the present invention. Water or other suitable diluents provided by a water or diluent source 54, is delivered under a source pressure to a diluent intake conduit 52. The source pressure of the liquid diluent is typically from 30 psi to 50 psi, or the pressure commonly associated with a domestic or principality water source. The diluent intake conduit 52 is connected in fluid communication to an inlet 60 of a boost pump 58. The boost pump 58 raises the pressure of the liquid diluent from the source pressure to a suitable elevated pressure for operating an aspirator. The outlet 62 of the boost pump 58 is connected in fluid communication to an anti-siphon valve 64 positioned in the flow path of conduit 66. Conduit 66 is in-turn connected in fluid communication to a valve 56. In one aspect of the present invention, valve 56 may be a three-way valve. In another aspect of the present invention, valve 56 may be separate valves for each leg of the dispensing system. A first leg 66A is connected in fluid communication to valve 56 and diluent inlet port 16A of aspirator assembly 12A. A second leg 66B of conduit 66 is connected in fluid communication to valve 56 and diluent inlet port 16B of aspirator assembly 12B. In the case where separate valves are utilized, both conduit legs 66A and 66B would be connected to separate, individual valves dedicated to each dispensing leg of conduit 66.

For purposes of illustrating the flow of liquid diluent and liquid product through the aspirator assemblies, aspirator assembly 12B is shown in cross-sectional view. As previously indicated, both aspirators 14A and 14B include a diluent inlet port 16A and 16B connected in liquid communication to valve 56 via legs 66A-B of conduit 66. As illustrated by aspirator assembly 12B, each aspirator assembly includes a diluent inlet port 16A and 16B. The diluent inlet port 16B is connected in liquid communication to the passageway 24B within aspirator body 22B, and aspirator assembly 12A is configured identically. Product inlet ports 18B-21B (and two not shown) are moved into fluid communication with passageway 24B within the aspirator body 22B by activation of solenoid valves 28B-31B (and two not shown). The aspirator body 22B includes an outlet port 26B connected in fluid communication to the passageway 24B. The aspirator 14B also includes four liquid product conduits 32B-35B (and two not shown) operably connected to each of the product inlet ports 18B-21B. Further details describing the various features, functions and structure of the aspirator assemblies 12A and 12B are included in application Ser. No. 11/206,618 incorporated by reference herein.

As illustrated in FIGS. 1-2, aspirator assembly 12A has product inlet ports 18A-21A connected in fluid communication to liquid product containers 48A-51A. Similarly, aspirator assembly 12B has liquid product inlet ports 18B-21B connected in fluid communication to liquid product containers 48B-51B. The liquid product containers 48A-51A house a first set of liquid products and liquid product containers 48B-51B house a second set of liquid products. The first set of liquid products may include one or more liquid products that are incompatible with the one or more liquid products of the second set of liquid products or vise versa. In this manner, incompatible liquid products are dispensed through separate aspirator assemblies 12A and 12B and thereby maintained in separation through the dispensing process. For example, the first set of liquid product containers 48A-51A could include high volume liquid products such as alkali, detergent, chlorine bleach or starch, and the second set of liquid product containers 48B-51B could include one or more finishing products such as a softener, acid, antichlor or starch.

In operation, a liquid, such as a liquid diluent, is communicated from a liquid or diluent source 54 through diluent intake conduit 52. The liquid diluent enters the boost pump 56 through inlet 60 and exits the boost pump 58 through outlet 52 at a pressure elevated from the source pressure associated with source 54. In one aspect of the invention the boost pump 56 raises the pressure of the liquid diluent from the source pressure associated with source 54 to a suitable elevated pressure for operating two or more aspirator assemblies configured in parallel or series. Liquid diluent is communicated through a conduit to an anti-siphon valve 64 such as an atmosphere pressure breaker which is commercially known and available. The liquid diluent is communicated from the anti-siphon valve 64 through conduit 66 to a valve 56. As shown, valve 56 comprises a three-way valve. In another aspect of the present invention, liquid diluent may be communicated through conduit 66 to a first valve, such as a solenoid valve, connected in fluid communication to aspirator assembly 12A and a second valve, such as a solenoid valve, connected in fluid communication to aspirator assembly 12B. Whether valve 56 is a three-way solenoid valve or individual solenoid valves, the valves are placed in the flow path of conduit 66 and utilized to open and close the flow of liquid diluent through legs 66A and 66B of conduit 66. Valve 56 includes a first open position for allowing liquid diluent to pass through conduit 66 into leg 66A, and a second open position to allow liquid diluent to pass through conduit 66 into leg 66B. Valve 56 may also be configured to have a third open position where liquid diluent is communicated through conduit 66 and both legs 66A and 66B at the same time. When valve 56 is in the first open position, liquid diluent is communicated through conduit 66 and leg 66A into diluent inlet port 16A of aspirator assembly 12A. Similarly, when valve 56 is in the second open position, liquid diluent is communicated through conduit 66 and leg 66B into the aspirator assembly 12B via diluent inlet port 16B. A suitable controller, not shown, may be connected in electronic communication with valve 56 to operate the valve between first and second open positions and a closed position. Similarly, the same or another suitable controller, not shown, may be connected in electronic communication with solenoid valves 28A-31A associated with aspirator assembly 12A and solenoid valves 28B-31B associated with aspirator assembly 12B. A control signal communicated from the controller to any one of the solenoid valves 28A-31A and 28B-31B actuates the valve between open and closed positions. In the open position, the product inlet port associated with the solenoid valve being actuated to the open position is brought into communication with a passageway 24B in aspirator body 22B illustrated in FIG. 1. As each product inlet port is connected in fluid communication with a liquid product container, actuation of the solenoid valve associated with the liquid product container to an open position places the liquid product within the liquid product container in communication with the passageway within the aspirator body of the respective aspirator assembly. By operation of an aspirator, which is well-known in the art, one of the liquid products 80A and 80B, such as a liquid concentrate, assuming a solenoid valve is activated, will be drawn from the respective liquid product containers 48A-51A and 48B-51B through liquid product conduits 32A-35A and 32B-35B. A flow meter (not shown) may also be placed in the flow path of the liquid product conduits 32A-35A and 32B-35B to ascertain an amount of the liquid product 80A or 80B being drawn from liquid product containers 48A-51A and 48B-51B. The particular liquid product being drawn from the liquid product containers 48A-51A and 48B-51B is communicated through liquid product conduits 32A-35A and 32B-35B into each of the aspirator assemblies 12A and 12B when a solenoid valve is actuated. The liquid product is then dispensed, along with the liquid diluent, as a mixed solution via the outlet port 26A or 26B. For example, liquid product containers 48A-51A may include such aqueous liquid products as high volume concentrates or finishing products used in laundry cleaning and sanitizing processes. This could include by way of an exemplary configuration of the present invention, liquid product container 48A having an alkali, liquid product container 49A having a detergent, liquid product container 50A having a chlorine bleach, and liquid product container 51A having a starch product. Similarly, liquid product containers 48B-51B could include one or more liquid products, such as finishing products for cleaning and sanitizing laundry. This could include liquid product container 48B having a softener, liquid product container 49B having an acid, liquid product container 50B having an antichlor, and liquid product container 51B having a starch product. In this configuration, it is known that the chlorine bleach and the acid are incompatible products. Thus, the chlorine bleach liquid product is dispensed through aspirator assembly 12B and the acid liquid product is dispensed through aspirator assembly 12A, both products being dispensed in separation from each other. These two, and other potentially incompatible liquid products, are dispensed in separation from one another to the appliance, such as the appliance 76 illustrated in FIG. 2. These incompatible liquid products are thereby maintained in separation through the dispensing process and through use by the appliance to prevent an unwanted chemical reaction from occurring, premature activation of a chemical, unwanted precipitants from developing and effectiveness of chemicals from being impaired.

Referring now specifically to FIG. 2, there is shown a dispensing system 10 of the present invention incorporated into a commercial laundry system. The dispensing system of the present invention could also be incorporated into a commercial warewashing system. Other cleaning and sanitizing systems are contemplated as circumstances may suggest and are rendered appropriate by incorporation of the present invention. As illustrated in FIG. 2, the four product inlet ports 18A-21A of aspirator assembly 12A are connected in liquid communication to four liquid product containers 48A-51A (containing the four liquid products to be dispensed) via liquid product conduits 32A-35A. These liquid products may include, in the case of the commercial laundry system shown, any one of the liquid products previously mentioned. Although specific products are listed above, the present invention contemplates that the liquid products contained in liquid product containers 48A-51A and 48B-51B may include any number of liquid products selected from detergents, sour/softener or souring agents, and/or chlorine bleach. The incompatible liquid products could be separated and maintained on different legs of the dispensing system. Like aspirator assembly 12A, the four product inlet ports 18B-21B of aspirator assembly 12B are connected in liquid communication to four product containers 48B and 51B (containing four liquid products to be dispensed) via liquid product conduits 32B-35B. As previously indicated, flow meters (not shown) may be placed in the flow path of liquid product conduits 32A-35A and 32B-35B. A suitable controller 70 provides a voltage connection to solenoid valves 28A-31A and 28B-31B and valve 56 through an electrical connection 74. The controller 70 receives a signal via connection 72 from appliance 76, such as a laundry machine. The outlet conduit 68A of aspirator assembly 12A and outlet conduit 68B of aspirator assembly 14B are connected in fluid communication to the appliance 76 to dispense a liquid product to the appliance 76. The appliance 76 sends a signal to controller 70 based on the desired liquid product being requested by the appliance 76, and an instruction is sent from the controller 70 through electrical connection 74 to actuate one of the solenoid valves 28A-31A associated with aspirator assembly 12A or solenoid valves 28B-31B associated with aspirator assembly 12B. The requested liquid product 80A or 80B is drawn from a liquid product container 48A-51A or 48B-51B and through one of the aspirator assemblies 12A or 12B. The liquid product and liquid diluent received from the liquid diluent source 54 is dispensed through outlet port 26A or 26B into the appliance 76 through respective outlet conduits 68A or 68B. When the requested amount of liquid product 80A or 80B has been dispensed from liquid product containers 48A-51A or 48B-51B, a signal is sent from the controller to actuate solenoid valves 28A-31A or 28B-31B to the closed position to discontinue dispensing of liquid product 80A or 80B to appliance 76. The controller 70 may maintain valve 56 in the open position for a short time to allow liquid diluent to continue to pass through one of the aspirator assemblies 12A or 12B to rinse out any remaining liquid product. Thus, by way of example, a single liquid diluent stream from a single liquid diluent source 54 may be communicated through one or both legs of the dispensing system simultaneously or sequentially based on the type of liquid product and the requested dispensing sequence of the liquid product requested at the appliance. For example, an instruction from the controller 70 opens the three-way valve so that leg 66A of conduit 66 is brought into fluid communication with the diluent source 54. Similarly, controller 70 may provide instructions to valve 56 to move to a second open position where leg 66B of conduit 66 is moved into fluid communication with diluent source 54. Other open/closed configurations for valve 56 are also contemplated. For example, controller 70 may provide instructions to valve 56 to move to a third open position whereby both legs 66A and 66B of conduit 66 are moved into fluid communication with the liquid diluent source 54 simultaneously. In another aspect of the present invention, each of the legs 66A and 66B of conduit 66 may have their own dedicated valve for placing the liquid diluent source 54 in fluid communication with the aspirator assemblies 12A and 12B either simultaneously or sequentially according to product being requested by the appliance 76. Using the dispensing system 10 of the present invention incorporated into a commercial laundry system, such as the system illustrated in FIG. 2, incompatible liquid products may be communicated independent and separate from one another to appliance 76 using the same liquid diluent source. For example, it is known that chlorine bleach and acids are incompatible liquid products. Therefore, the present invention allows the chlorine bleach to be included in one of the liquid product containers 48A-51A in the first leg of the system and the acid to be included in one of the liquid product containers 48B-51B in the second leg of the dispensing system. Other incompatible liquid products may also be separated accordingly. Thus, as the appliance 76 requests a specific liquid product, the controller 70 issues an instruction to one or more of the solenoid valves 28A-31A or 28B-31B to place the desired liquid product in fluid communication with the aspirator by opening the respective solenoid valve. If the liquid product being requested is on aspirator assembly 12A, the liquid product and liquid diluent (the resulting mixed solution) is communicated through outlet conduit 68A to appliance 76. Similarly, if the liquid product being requested is on aspirator assembly 12B, the liquid product is communicated with the diluent as a mixed solution to the appliance 76 through outlet conduit 68B.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for dispensing incompatible liquid products from a dispenser, comprising:
providing a first and second aspirator each having a diluent inlet port, a plurality of product inlet ports and an outlet port;
aspirating a first liquid product through a product inlet port of the first aspirator;
aspirating a second liquid product incompatible with the first liquid product through a product inlet port of the second aspirator; and
dispensing the first liquid product out an outlet port of the first aspirator and the second liquid product out an outlet port of the second aspirator in separation from the first liquid product.

2. The method of claim 1 further comprising the step of aspirating at least two liquid products through the first or second aspirator.

3. The method of claim 1 further comprising the step of providing a liquid diluent at a source pressure and increasing the source pressure to an elevated pressure.

4. The method of claim 3 further comprising the step of aspirating the first and second liquid product through the first and second aspirators by passing the liquid diluent at the elevated pressure through the diluent inlet port of each aspirator.

5. The method of claim 1 in combination with a laundry system.

6. The method of claim 1 wherein the first liquid product is an acid and the second liquid product is a chlorine bleach.

7. A method for dispensing incompatible liquid products from a dispenser, comprising:
providing a first and second aspirator each having a diluent inlet port, a plurality of product inlet ports and an outlet port;
aspirating a first set of liquid products through the plurality of product inlet ports of the first aspirator;
aspirating a second set of liquid products through the plurality of product inlet ports of the second aspirator, wherein at least one of the liquid products of the second set is incompatible with a liquid product of the first set; and
dispensing liquid products of the first set out the outlet port of the first aspirator and in separation from the incompatible liquid product of the second set dispensed out the outlet port of the second aspirator to preserve the effectiveness of each liquid product.

8. The method of claim 7 wherein at least one incompatible product of the first set of liquid products is an acid.

9. The method of claim 8 further comprising the step of aspirating each liquid product of the first set through the first aspirator and the second set through the second aspirator.

10. The method of claim 7 wherein at least one incompatible product of the second set of liquid products is a chlorine bleach.

11. A method for dispensing and preserving the effectiveness of liquid products during dispensing, comprising:
providing at least two aspirators each having a diluent inlet port, a plurality of product inlet ports and an outlet port;
passing a liquid diluent at a pressure elevated from its source pressure through the diluent inlet port of each aspirator;
selectively aspirating a first set of liquid products through the plurality of product inlet ports of the first aspirator separately from a second set of liquid products through the plurality of product inlet ports of the second aspirator; and
dispensing at least one of the liquid products of the first set out the outlet port of the first aspirator and at least one of the liquid products of the second set out the outlet port of the second aspirator in separation from each other to preserve the effectiveness of each product.

12. The method of claim 11 wherein at least one of the liquid products aspirated from the second set is incompatible with a liquid product aspirated from the first set.

13. The method of claim 11 wherein each liquid product is aspirated from a liquid product source by passing the liquid diluent at the elevated pressure through the diluent inlet port of the first and second aspirator.

14. The method of claim 11 further comprising the step of aspirating at least two liquid products through the first and second aspirator.

15. A product dispensing system configured to dispense incompatible liquid products, comprising:
a boost pump having a pump inlet for receiving a liquid diluent at a source pressure and a pump outlet for delivering the liquid diluent at an elevated pressure;
a first and second aspirator each having a diluent inlet port for receiving the liquid diluent at the elevated pressure, a plurality of product inlet ports for receiving a liquid product and an outlet port for dispensing;
a first set of the liquid products connected in liquid communication to the plurality of product inlet ports of the first aspirator for aspirating each liquid product into the first aspirator;
a second set of liquid products connected in liquid communication to the plurality of product inlet ports of the second aspirator for aspirating each liquid product into the second aspirator; and
at least one product of the second set of liquid products being incompatible with at least one product of the first set of liquid products.

16. The product dispensing system of claim 15 wherein at least one product of the first set of liquid products is aspirated solely through the first aspirator to prevent combination with an incompatible product of the second set of liquid products.

17. The product dispensing system of claim 16 wherein the incompatible product of the second set of liquid products is a chlorine bleach.

18. The product dispensing system of claim 15 wherein at least one product of the second set of liquid products is aspirated solely through the second aspirator to prevent combination with an incompatible product of the first set of liquid products.

19. The product dispensing system of claim 18 wherein the incompatible product of the first set of liquid products is an acid.

20. The product dispensing system of claim 15 wherein the second aspirator is dedicated for dispensing a liquid product that is incompatible with at least one product of the first set of liquid products.
